(19) United States
(12) Patent Application Publication
(10) Pub. No.: US 2025/0038782 A1
(43) Pub. Date: Jan. 30, 2025

(54) SMART RING

(71) Applicant: Jianhui Wu, Leping (CN)

(72) Inventors: Jianhui Wu, Leping (CN); Yuan Wang, Leping (CN); Yuanwei Wang, Leping (CN)

(21) Appl. No.: 18/916,341

(22) Filed: Oct. 15, 2024

(30) Foreign Application Priority Data
Sep. 13, 2024 (CN) 202422249263.8

(51) Int. Cl. H04B 1/3827

(52) U.S. Cl. CPC H04B 1/385; H04B 2001/3861

(57) ABSTRACT

The present disclosure discloses a smart ring, including a ring body; a circuit board assembly and a storage battery are packaged in the ring body; a control chip and a near field communication (NFC) chip are packaged on the circuit board assembly; the ring body includes a finger ring stand; a coil is laid on a circumferential wall surface of the finger ring stand; and the coil is arranged around the circumferential wall surface of the finger ring stand, and is electrically connected to the circuit board assembly. Compared with the traditional arrangement of the NFC signal communication antenna in a partial region, the circumferential arrangement can effectively expand a signal receiving range and improve the signal receiving sensitivity, making wireless communication more sensitive and more stable.

### TECHNICAL FIELD

The present disclosure relates to the technical field of smart equipment, and in particular, to a smart ring.

### BACKGROUND

With the development of Internet technologies and smart products, a variety of smart wearable products have appeared on the market. All kinds of smart wearable products are used to achieve various detection and monitoring functions, and achieve intelligence in conjunction with the Internet. Unlike a traditional ring, a smart ring has different electronic functions and can be flexibly designed in its form according to a need. The common smart ring integrates a flexible printed circuit board and various kinds of sensors inside, which can monitor various physical data of a human body through the sensors.

Due to a small size of the smart ring, the capacity of a built-in battery of the smart ring needs to be minimized as much as possible on the premise of meeting its basic working need, so as to reduce a limited storage space occupied by the battery. However, the capacity of the battery and the battery life of the battery are theoretical in an inverse relationship. This is unsatisfactory.

Therefore, the application of a Near Field Communication (NFC) technology to recharging the smart ring has emerged. If the smart ring is internally packaged with an NFC charging circuit module, wireless charging power transfer can be provided for the smart ring through NFC equipment, such as a mobile phone, with an NFC signal transmission port, so that the built-in battery of the smart ring can be charged to supplement electric energy. However, an NFC signal communication antenna that is arranged in the smart ring and used for receiving charging power transfer is basically integrated and packaged on a flexible printed circuit board. From the overall vision of the smart ring, the NFC signal communication antenna is arranged on a side wall of a ring body, and NFC is a near low-frequency transmission wireless communication technology. When the smart ring intends to establish transmission connection to NFC equipment, a body of a portion, on which the NFC signal communication antenna is located, of the ring body needs to be used to approach the NFC equipment, in order to successfully establish the transmission connection. This operation mode with a limited signal receiving range cannot meet a portable use need of a user. In addition, normal achievement of a charging function will often be affected by unstable connection of a transmission line.

### SUMMARY

The present disclosure aims to provide a smart ring. A receiving coil is arranged in a circumferential direction of a finger ring stand; the coil is used to replace a traditional NFC signal communication antenna, so that an NFC electromagnetic charging receiving coil and the NFC signal communication antenna are integrated into a single antenna, which is conductive to structural optimization. It can further effectively expand a signal receiving range and make wireless communication more sensitive and more stable, thereby solving the problems mentioned in the background section.

To achieve the above objectives, the present disclosure provides the following technical solutions: A smart ring includes a ring body; a circuit board assembly and a storage battery are packaged in the ring body; the circuit board assembly is electrically connected to the storage battery; a control chip and an NFC chip are packaged on the circuit board assembly; the ring body includes a finger ring stand; a coil is laid on a circumferential wall surface of the finger ring stand; and the coil is arranged around the circumferential wall surface of the finger ring stand, and is electrically connected to the circuit board assembly.

Preferably, the coil is arranged on one side of an inner wall of the finger ring stand and is coaxial with the finger ring stand.

Preferably, the coil (2) is an NFC electromagnetic charging receiving coil and/or an NFC signal communication antenna.

Preferably, the circuit board assembly is a flexible printed circuit board assembly, and the flexible printed circuit board assembly abuts against an inner wall surface of the finger ring stand.

Preferably, the circuit board assembly is electrically connected with a power port.

Preferably, the ring body includes a potting adhesive layer; the potting adhesive layer is packaged on one side of the inner wall of the finger ring stand; and the circuit board assembly, the storage battery, the control chip, the NFC chip, and a Bluetooth module are all packaged inside the potting adhesive layer.

Preferably, a side wall surface of the potting adhesive layer away from the finger ring stand is set as an annular curved surface extending axially inward.

Preferably, the annular curved surface converges to an axial middle section of the potting adhesive layer from the highest point.

Preferably, the finger ring stand is a metal ring; an insulation partition strip is embedded on the metal ring; and the insulation partition strip cuts off a closed form of the metal ring.

Preferably, the finger ring stand is a ceramic ring.

Compared with the prior art, the present disclosure has the beneficial effects below:

In the present disclosure, the receiving coil is arranged in a circumferential direction of the finger ring stand. The coil is used to replace a traditional NFC signal communication antenna, so that an NFC electromagnetic charging receiving coil and the NFC signal communication antenna are integrated into a single antenna, which is conductive to structural optimization. Since the coil is arranged in the circumferential direction of the finger ring stand, the detection range of the coil is enlarged to the maximum extent. Compared with the traditional arrangement of the NFC signal communication antenna in a partial region, the circumferential arrangement can effectively expand a signal receiving range and improve the signal receiving sensitivity, making wireless communication more sensitive and more stable.

### BRIEF DESCRIPTION OF THE DRAWINGS

FIG. 1 is a structural exploded diagram of the present disclosure; and

FIG. 2 is a schematic diagram of an appearance of the present disclosure.

In the drawings: 1: finger ring stand; 11: insulation partition strip; 2: coil; 3: circuit board assembly; 31: power port; 32: control chip; 33: NFC chip; 4: storage battery; 5: potting adhesive layer; and 51: annular curved surface.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all the embodiments. All other embodiments obtained by a person of ordinary skill in the art based on the embodiments of the present disclosure without making creative efforts shall fall within the protection scope of the present disclosure.

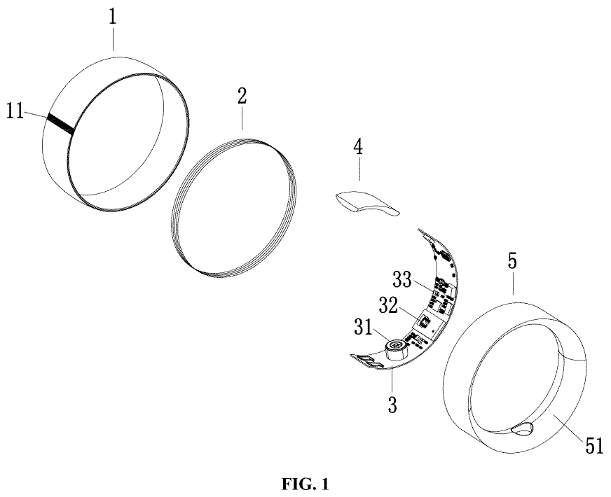

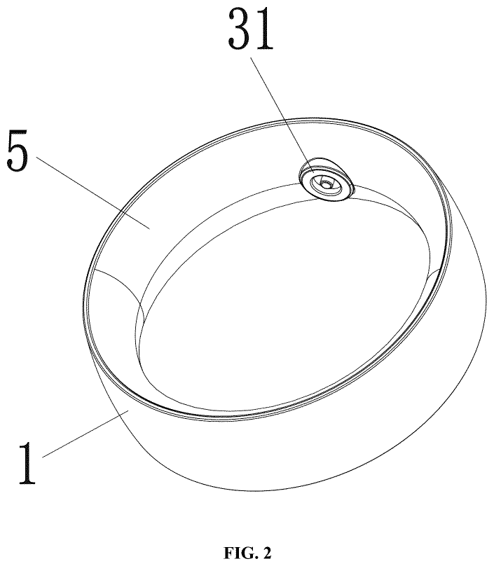

Referring to FIG. 1 to FIG. 2, a smart ring includes a ring body. A circuit board assembly 3 and a storage battery 4 are packaged in the ring body; the circuit board assembly 3 is electrically connected to the storage battery 4; a control chip 32 and an NFC chip 33 are packaged on the circuit board assembly 3; the ring body includes a finger ring stand 1; a coil 2 is laid on a circumferential wall surface of the finger ring stand 1; and the coil 2 is arranged around the circumferential wall surface of the finger ring stand 1, and is electrically connected to the circuit board assembly 3.

In this embodiment, the coil 2 is arranged on one side of the inner wall of the finger ring stand 1 and is coaxially arranged with the finger ring stand 1. The circuit board assembly 3 is a flexible printed circuit board assembly, and both the flexible printed circuit board assembly and the storage battery abut against the inner wall surface of the finger ring stand 1 and are located on one side of the coil 2 away from the finger ring stand 1. The circuit board assembly 3 is provided with a power port 31 in an electric connection manner. The ring body includes a potting adhesive layer 5 which is encapsulated on one side of the inner wall of the finger ring stand 1. The circuit board assembly 3, the storage battery 4, the control chip 32, and the NFC chip 33 are all packaged in the potting adhesive layer 5. An outer docking end of the power port 31 extends to an outer side of the potting adhesive layer 5 and can be docked to an external charging cable port to achieve power supplying and connection.

The coil 2 includes an NFC electromagnetic charging receiving coil and an NFC signal communication antenna. When it approaches NFC equipment, the coil can achieve wireless signal communication with the NFC equipment. The storage battery 4 is charged by receiving a transmission signal of a communication antenna of the NFC equipment (e.g. a mobile phone) for electromagnetic resonance coupling to obtain radio energy. The coil can further perform read-write communication with the NFC equipment.

A side wall surface of the potting adhesive layer 5 away from the finger ring stand 1 is set as an annular curved surface 51 extending axially inward. The annular curved surface 51 converges at an axial middle section of the potting adhesive layer 5 from the highest point. The shape of the annular curved surface 51 can minimize a contact area between the ring body worn on a finger and the finger, making the permeability of the finger during wearing better and making a user feel comfortable when wearing the ring. Moreover, the presence of the annular curved surface 51 allows one side of the coil 2 face the finger to be exposed, so that it is more sensitive and stable for the coil 2 to receive signals.

The finger ring stand 1 can flexibly use a metal ring, a ceramic ring, etc. according to a need of a user. When the metal ring is selected, an insulation partition strip 11 is embedded on the metal ring, and the insulation partition strip 11 cuts off a closed form of the metal ring, to avoid the metal ring from shielding the signal of the coil 2. The insulation partition strip 11 can use a silica gel strip, a plastic strip, a ceramic strip, etc.

In summary, in the present disclosure, the receiving coil 2 is arranged in a circumferential direction of the finger ring stand 1. The coil 2 is used to replace a traditional NFC signal communication antenna, so that an NFC electromagnetic charging receiving coil and the NFC signal communication antenna are integrated into a single antenna, which is conductive to structural optimization. Since the coil 2 is arranged in the circumferential direction of the finger ring stand 1, the detection range of the coil is enlarged to the maximum extent. Compared with the traditional arrangement of the NFC signal communication antenna in a partial region, the circumferential arrangement can effectively expand a signal receiving range and improve the signal receiving sensitivity, making wireless communication more sensitive and more stable.

It should be noted that in this document, relationship terms such as first and second are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device.

Although the embodiments of the present disclosure have been shown and described, it can be understood by those of ordinary skill in the art that various changes, modifications, substitutions, and variations can be made to these embodiments without departing from the principle and spirit of the present disclosure. The scope of the present disclosure is defined by the accompanying claims and their equivalents.

What is claimed is:

1. A smart ring, comprising a ring body, wherein a circuit board assembly (3) and a storage battery (4) are packaged in the ring body; the circuit board assembly (3) is electrically connected to the storage battery (4); a control chip (32) and a near field communication (NFC) chip (33) are packaged on the circuit board assembly (3); the ring body comprises a finger ring stand (1); a coil (2) is laid on a circumferential wall surface of the finger ring stand (1); and the coil (2) is arranged around the circumferential wall surface of the finger ring stand (1), and is electrically connected to the circuit board assembly (3).

2. The smart ring according to claim 1, wherein the coil (2) is arranged on one side of an inner wall of the finger ring stand (1) and is coaxial with the finger ring stand (1).

3. The smart ring according to claim 1, wherein the coil (2) is an NFC electromagnetic charging receiving coil and/or an NFC signal communication antenna.

4. The smart ring according to claim 1, wherein the circuit board assembly (3) is a flexible printed circuit board assembly, and the flexible printed circuit board assembly abuts against an inner wall surface of the finger ring stand (1).

5. The smart ring according to claim 1, wherein the circuit board assembly (3) is electrically connected with a power port (31).

6. The smart ring according to claim 1, wherein the ring body comprises a potting adhesive layer (5); the potting adhesive layer (5) is packaged on one side of the inner wall of the finger ring stand (1); and the circuit board assembly (3), the storage battery (4), the control chip (32), the NFC chip (33), and a Bluetooth module (34) are all packaged inside the potting adhesive layer (5).

7. The smart ring according to claim 6, wherein a side wall surface of the potting adhesive layer (5) away from the finger ring stand (1) is set as an annular curved surface (51) extending axially inward.

8. The smart ring according to claim 7, wherein the annular curved surface (51) converges to an axial middle section of the potting adhesive layer (5) from the highest point.

9. The smart ring according to claim 1, wherein the finger ring stand (1) is a metal ring; an insulation partition strip (11) is embedded on the metal ring; and the insulation partition strip (11) cuts off a closed form of the metal ring.

10. The smart ring according to claim 1, wherein the finger ring stand (1) is a ceramic ring.
